(19) United States
(12) Patent Application Publication
(10) Pub. No.: US 2020/0043272 A1
(43) Pub. Date: Feb. 6, 2020

(54) BELT CONVEYOR BUCKET

(71) Applicant: Swyft Inc., San Franicsco, CA (US)

(72) Inventors: Diego Vazquez, Antioch, CA (US); Lincoln Smith, San Francisco, CA (US); Gower Smith, San Francisco, CA (US)

(73) Assignee: Swyft Inc., San Franicsco, CA (US)

(21) Appl. No.: 16/530,924

(22) Filed: Aug. 2, 2019

Related U.S. Application Data
(60) Provisional application No. 62/713,982, filed on Aug. 2, 2018.

(51) Int. Cl. G07F 11/16; G07F 11/42; G07F 11/62; G07F 11/22

(52) U.S. Cl. CPC G07F 11/165; G07F 11/22; G07F 11/62; G07F 11/42

(57) ABSTRACT

Methods and apparatuses provide a vending machine with a positioning system connected to a dispensing chassis. The dispensing chassis includes a retractable partition. The positioning system moves the dispensing chassis to receive product from a shelf of the vending machine and closes the retractable partition. The positioning system moves the dispending chassis and product to a dispensing position. A dispensing door is raised allowing a user to remove the product. With the door raised the retractable partition and chassis prevent unauthorized user access to other products within the vending machine.

### CROSS-REFERENCE TO RELATED CASES

The present application claims priority to U.S. Provisional Patent Application No. 62/713,982, “Belt Conveyor Bucket,” filed on Aug. 2, 2018, which is incorporated by reference.

### TECHNICAL FIELD

The present subject matter relates to the field of vending machines and more particularly to methods and apparatus for dispensing products from vending machines.

### BACKGROUND

Current vending machines require ramps and chutes or free-fall of product to direct product from the vending machine shelves to a dispensing door. Such ramps and chutes take up valuable machine interior space. In addition, the fall from a shelf to the chute may damage the product. Furthermore, the chutes and ramps may not adequately prevent the unauthorized removal of product from the dispensing door.

It is therefore desirable to have a system for providing product that does not require ramps or chutes, does not potentially damage the product, and hinders the unauthorized removal of product from the vending machine.

### BRIEF SUMMARY

In an embodiment, a vending machine includes a dispensing chassis (or “bucket”) and a positioning system that moves the dispensing chassis to a shelf to receive product. Once the product is on a conveyor of the chassis, the chassis closes a partition on the shelf-side of the chassis. The positioning system moves the chassis and product to a dispensing position behind a dispensing door. The vending machine then opens the door, allowing the user to remove the product. With the door open, the partition prevents the user from reaching through the chassis to access other products within the vending machine. In addition, the elimination of chutes and ramps allows more space for shelves (and product) within the vending machine.

In an embodiment, the conveyor mechanism in the bucket allows for products to be smoothly transferred from the shelf into the bucket. The bucket contains dispense engagement gears on either side of the bucket to be able to reach and dispense from the left or right side of the bucket, allowing the machine to maximize its capacity. There are arrays of cameras and sensors built into the bucket to ensure accurate product detection.

### BRIEF DESCRIPTION OF THE DRAWINGS

The embodiments are illustrated by way of example and not limitation in the figures of the accompanying drawings, in which like references indicate similar elements, and in which:

FIG. 1 depicts an embodiment of a belt conveyor bucket incorporated into a vending machine;

FIG. 2 depicts a mechanism for positioning an embodiment of a belt conveyor bucket within a vending machine;

FIG. 3 is a perspective view depicting an embodiment of a belt conveyor bucket;

FIG. 4 is a transparent perspective rear view of aspects of an embodiment of a belt conveyor bucket;

FIG. 5 is an expanded perspective view of an embodiment of a belt conveyor product;

FIG. 6 is a perspective view depicting details of an embodiment a belt conveyor product;

FIG. 7 is a perspective view depicting details of a belt conveyor from an embodiment a belt conveyor product;

FIG. 8 is a transparent side view depicting details of a belt conveyor from an embodiment a belt conveyor product;

FIG. 9 is a transparent perspective view depicting details of a belt conveyor from an embodiment a belt conveyor product;

FIG. 10A is a partial side view depicting details of a belt conveyor from an embodiment of a belt conveyor product;

FIG. 10B is a partial side view depicting details of a belt conveyor from an embodiment of a belt conveyor product;

FIG. 11 is a partially transparent upper perspective view depicting details of a mechanism for positioning an embodiment of a belt conveyor product within a vending machine;

FIG. 12 is a perspective view depicting details of a mechanism for positioning an embodiment of a belt conveyor product within a vending machine;

FIG. 13 is a perspective view depicting details of a mechanism for positioning an embodiment of a belt conveyor product within a vending machine;

FIG. 14 is a perspective view depicting details of a mechanism for positioning an embodiment of a belt conveyor product within a vending machine;

FIG. 15A is a schematic depicting details of a mechanism for positioning an embodiment of a belt conveyor product within a vending machine;

FIG. 15B is a perspective view depicting details of a mechanism for positioning an embodiment of a belt conveyor product within a vending machine;

FIG. 16 is a simplified, exemplary block diagram of an embodiment of a system for controlling a belt conveyor bucket; and

FIG. 17 is an exemplary block diagram of a computing device from the system of FIG. 16.

### DETAILED DESCRIPTION

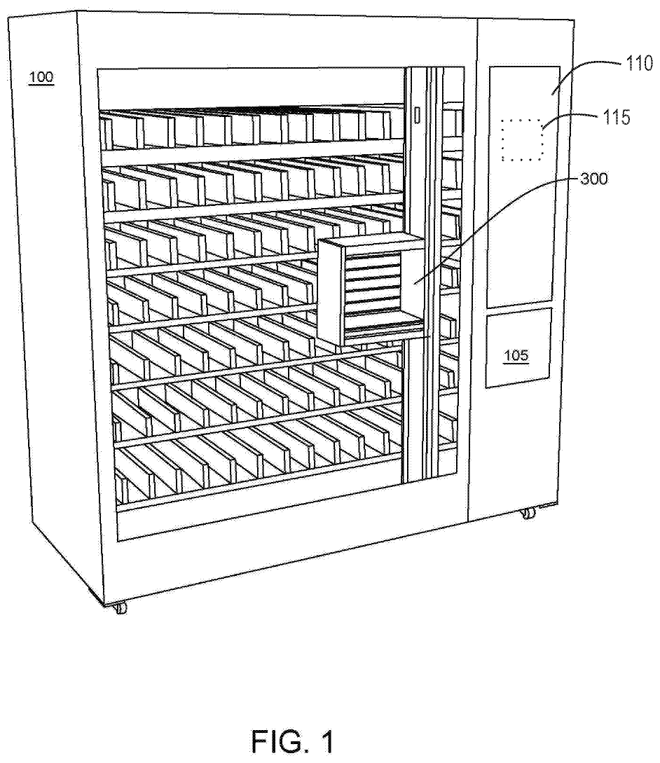

FIG. 1 depicts an embodiment of a belt conveyor bucket 300 incorporated into a vending machine 100. Vending machine 100 includes an interface panel 110 which allows a user to interface with a controller 115, which includes one or more processors and memory with instructions for controlling the systems of vending machine 100.

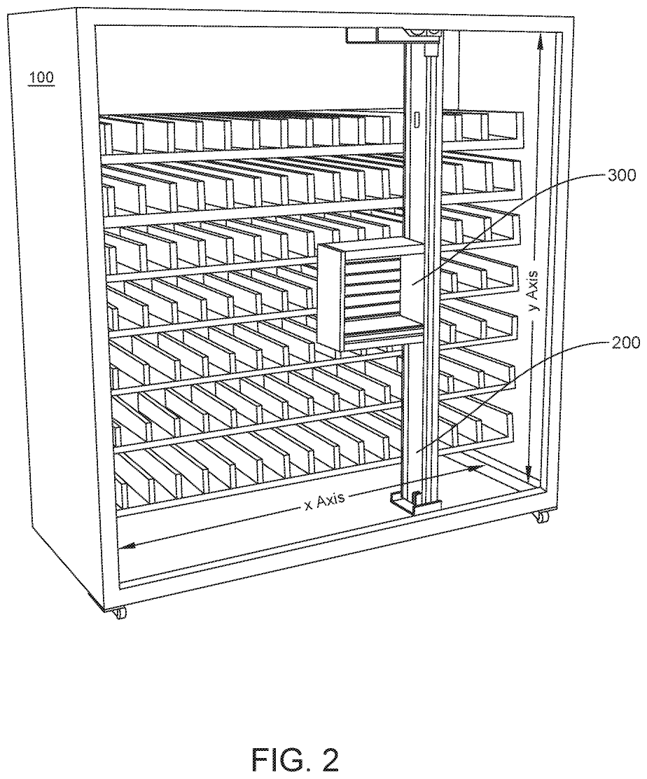

FIG. 2 depicts a mechanism for positioning an embodiment of belt conveyor bucket 300 within vending machine 100 using a positioning mechanism 200 that positions belt conveyor bucket 300 in the X and Y directions as directed by controller 115 to line up belt conveyor bucket 300 with a particular shelf and with a product on that shelf.

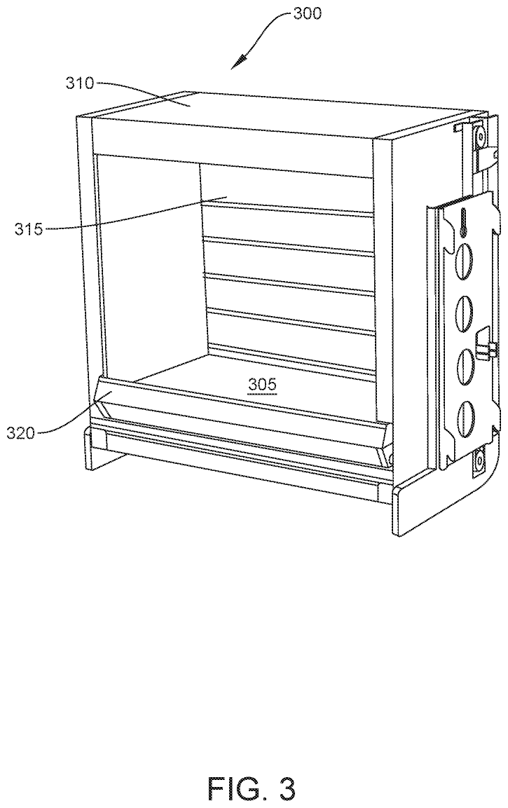

FIG. 3 is a perspective view depicting an embodiment of belt conveyor bucket 300. In embodiments, belt conveyor bucket 300 is a device used to transport products from the storage shelves of vending machine 100 to delivery door 105 as directed by controller 115. Belt conveyor bucket 300 includes a conveyor belt 305 which delivers products from a vending machine shelf (behind a curtain system 315) and to delivery door 105, past a retracting front stop 320 (or “conveyor end stop” or “front barrier”). A feature provided by the embodiment is a stable transfer of the product as it moves from the vending machine shelf (behind curtain 315) to the conveyor belt 305 (FIG. 3). The stable transfer is made possible by having speed control of belt 305 and by eliminating spaces where thin packages may become stuck.

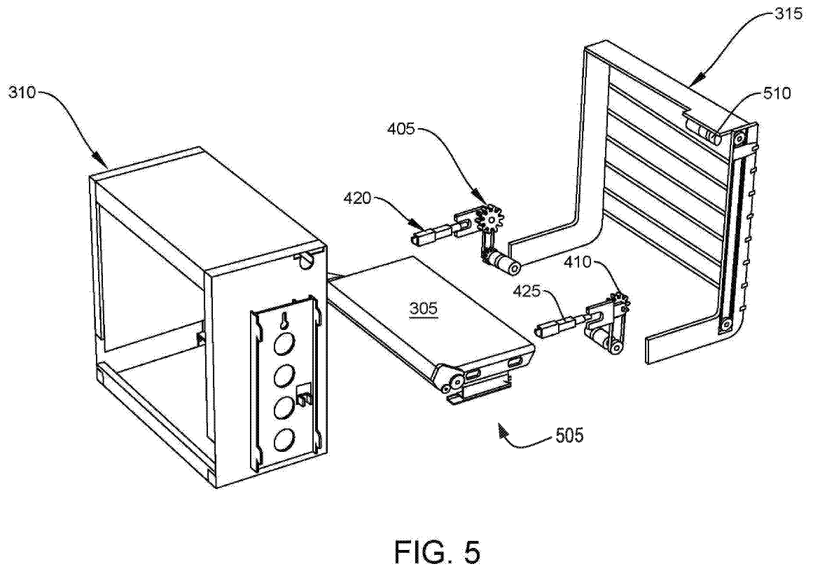

In the embodiment, curtain system 315 (also known as a “partition,” “safety curtain,” or “garage door”) serves to block access to items stored on the shelves so that they cannot be taken without having been paid for. The closing of curtain 315 prior to moving a product also serves to prevent that product from contacting other parts of the vending machine or shelved products as the purchased product is transported to the dispensing area. In an embodiment, curtain system 315 may be made of high performance cut- and slash-resistant fabric. In an embodiment, curtain system 315 includes a transmission system 510 (FIG. 5) with a 24DVC gearmotor, and 2 limit sensors (not shown) to detect the closed and open position and provide the information to controller 115.

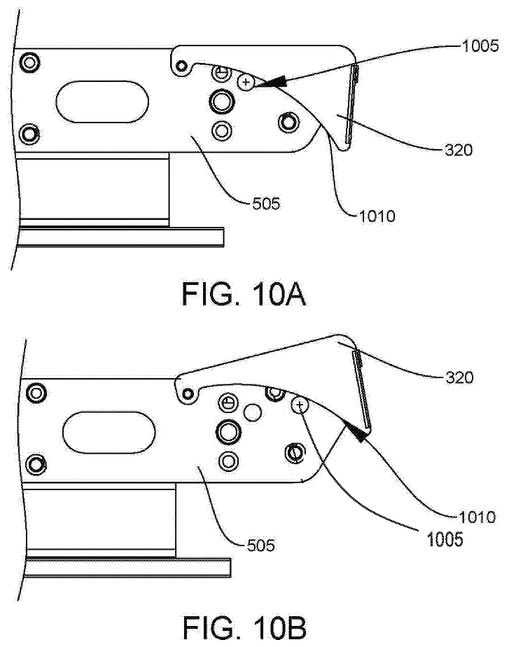

In the embodiment, front stop 320 may be a metallic part that retains the products on the front side of the conveyor belt 305. Front stop 320 rises when the conveyor retracts and lowers when the conveyor extends forward (described further with reference to FIG. 10).

In an embodiment, the front stop 320 is replaced by a mechanism similar to or identical to the curtain system 315, to stop the product from falling out the front side of the conveyor bucket. In an embodiment, the front-side curtain may be pulled open or otherwise activated by the mechanical dispense door on the front of the vending machine dispense area. In this embodiment, the bucket front door is passive and be driven by the vending machine dispense door, which is motorized).

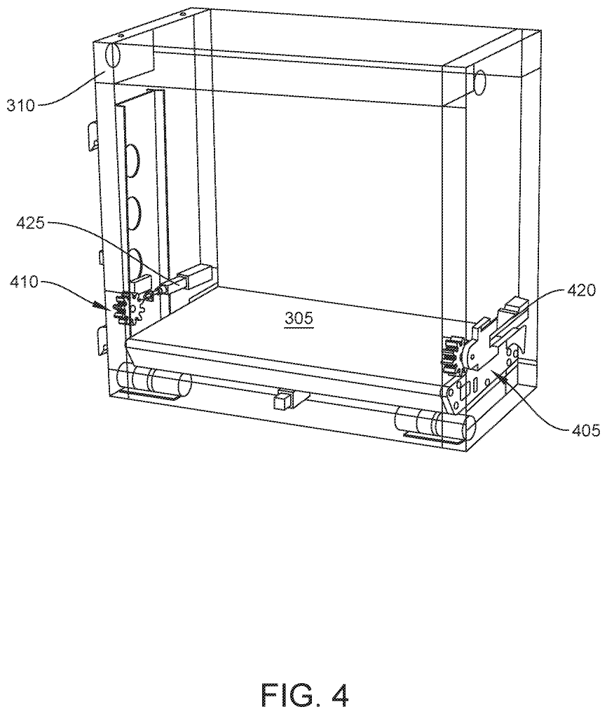

FIG. 4 is a partially transparent perspective rear view of aspects of an embodiment of belt conveyor bucket 300. FIG. 4 illustrates aspects of a dual drive gear mechanism (gear drive 405 and gear drive 410) that provides motive power to the pusher (not shown), which is a mechanism on a shelf divider of vending machine 100 that pushes product forward (in this case onto belt 305) at the direction of controller 115. The dual drive gear mechanism 405, 410 is located on the side walls of bucket 300. The dual drive gear mechanism includes a left-hand gear drive 405, a right-hand gear drive 410, and linear actuators 420, 425. One of gear drives 405, 410 engages a corresponding gear on the divider on a shelf of vending machine 100. Rotation of the single gear drive then drives the pusher on the divider to move a product forward. The gear drive, either gear drive 405 or 410, depending on the side on which the divider is positioned, couples in a straight line to a front gear of the divider, preventing divider gear movement that may cause an involuntary dispensing of product. The appropriate actuator, ether actuator 420, 425, moves the drive gear forward to engage with the drive gear on the divider. The drive gear on bucket 310 is driven by a 24vdc electric motor. The dual drive gear mechanism provides an advantage in that each side may be independent, allowing the control of the speed of each gear as well as the linear speed of coupling of the gears. Thus, the dual drive mechanism is able to activate dividers equipped with both left and right hand pushers (where the dividers are in the shelf of the vending machine). This allows placing dividers on both the left and right ends of a shelf and expands the capacity of the vending machine to store more products in the ready-to-be dispensed state.

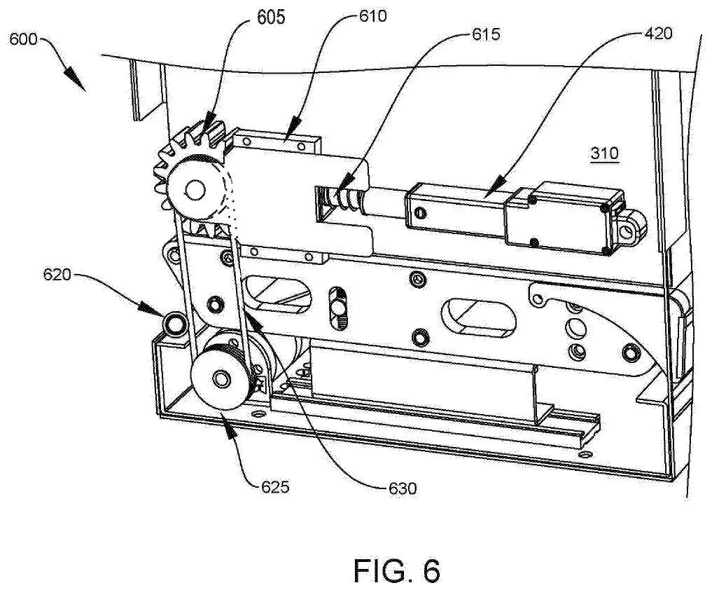

In an embodiment, when one drive mechanism is activated to contact a divider an dispense product, the other divider is also positioned against a divider. Thus, both drive mechanisms 405, 410 are positioned to contact dividers of vending machine 100, compensating for potential misalignment with the use of a compression spring on each linear actuator shaft (e.g., FIG. 6, tension spring 615).

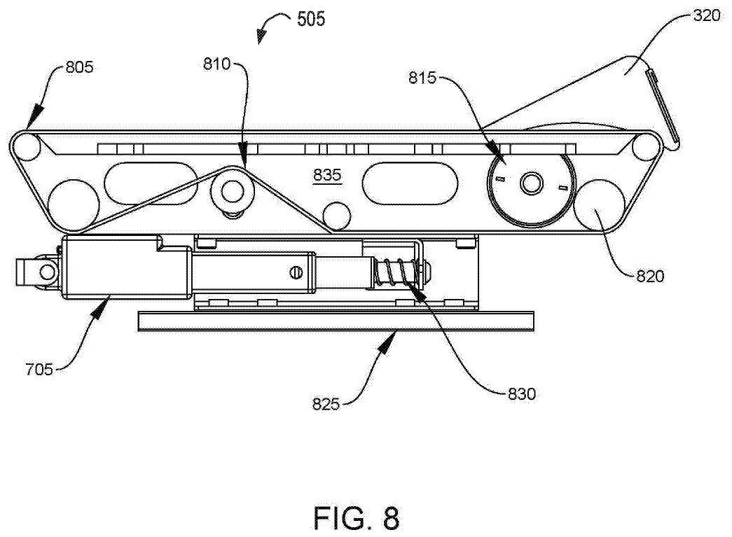

FIG. 5 is an expanded perspective view of an embodiment of belt conveyor bucket 300. In the embodiment, belt conveyor 505 has a compact and modular design, with fewer mobile parts, which makes it easier to repair and cost less to maintain. Belt conveyor 505 includes a belt tensioner (take-up roller 810, FIG. 8) and a dc gearmotor (815, FIG. 8) located inside a conveyor frame (835, FIG. 8) and directed by controller 115. Curtain system 315 is shown with transmission system 510 described earlier.

FIG. 6 is a perspective view depicting details of an embodiment of belt conveyor bucket 300. In FIG. 6, a pusher drive gear mechanism 600 includes a pulley 625 driven by a DC motor in turn controlled by controller 115. Pulley 625 drives a gear/pulley 605 by way of a round belt 630. A round belt take-up 620 insures proper tension in round belt 630. Gear/pulley 605 in turn drives gear/drive 405. Pusher drive gear mechanism 600 further includes linear actuator 420, a tension spring 615, and a linear guide 610. Spring 615 maintains the contact in the coupling between gear drive 405 of bucket 300 and the drive gear of the corresponding divider, and also compensates for misalignments between chassis 310 and the vending machine shelf. Compensating for misalignment is a feature of the embodiment. Preferably, the drive gear 605 moves directly forward to engage with the dispenser drive gear. If the two drive gears engage at an angle it may cause the gear to rotate slightly. And if the dispenser drive gear rotates, it could cause product to be pushed slightly, which could cause the product to accidentally vend or jam.

In an embodiment, the chassis includes a magnetic sensor on each side near the drive gears. Each magnetic sensor is used to detect a magnet that sits inside the shelf dispenser. The magnetic sensors allow the chassis to detect the exact location of the shelf dispenser that it is engaging. When the shelf dispenser becomes increasingly small it is extremely important that the chassis is able to accurately engage with it, otherwise the product on the shelf may actually catch on the bucket and mis-vend. In an embodiment, the chassis includes a laser sensor that sits right above the drive gear and that directs a laser down the shelf dispenser. That laser receives a reflected signal that measures the distance from the laser to a tab on a carriage of the shelf dispenser. The shelf dispenser tab is located on the carriage, which is behind the products on the shelf. With the distance information provided by the reflected signal, a controller is able to use the chassis to detect the distance from the chassis to the furthest back product. With product size information, the controller is able to divide that distance by the depth of product to understand how many products are on the shelf, e.g., if a 92 mm depth is detected, and each product is 18 mm deep, then there are 5 products on the shelf.

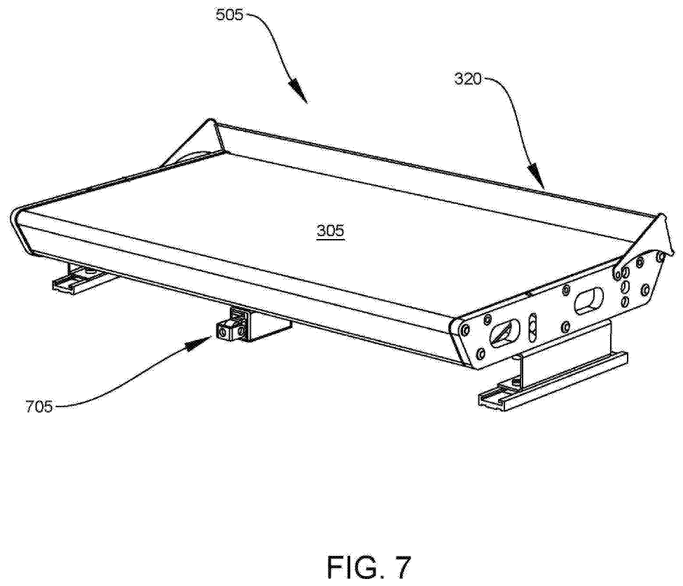

FIG. 7 is a perspective view depicting details of belt conveyor 505. Belt conveyor 505 includes a linear actuator 705 (directed by controller 115), which works against chassis 310 to retract and extend belt 305.

FIG. 8 is a transparent side view depicting details of belt conveyor 505. In the embodiment, gaps between both the vending machine shelf and the dispensing door 105 are minimized by the actuator 705. The embodiment uses linear actuator 705 moving in both directions to eliminate gaps between belt conveyor nose roller 805 and vending machine shelf edge, and between the other end of belt conveyor 505 and the delivery door frame. In FIG. 8, a compression spring 830 maintains contact between the surfaces (i.e., between the vending machine shelf and the nose roller), and compensation in case of misalignment between transfer areas. Belt conveyor 505 includes a conveyor frame 835 provided with nose roller 805, a take-up roller 810, and a drive roller 820 driven by a gear motor 815. Frame 835 includes additional rollers. Belt 305 moves about the various rollers as indicated. Frame 835 is supported by a linear rail 825 and moves along rail 825 when extended and retracted by actuator 705.

In an embodiment, actuator 705 may also cause belt 305 to extend through the opening of dispenser door 105 when opened to deposit product out of dispenser door 105.

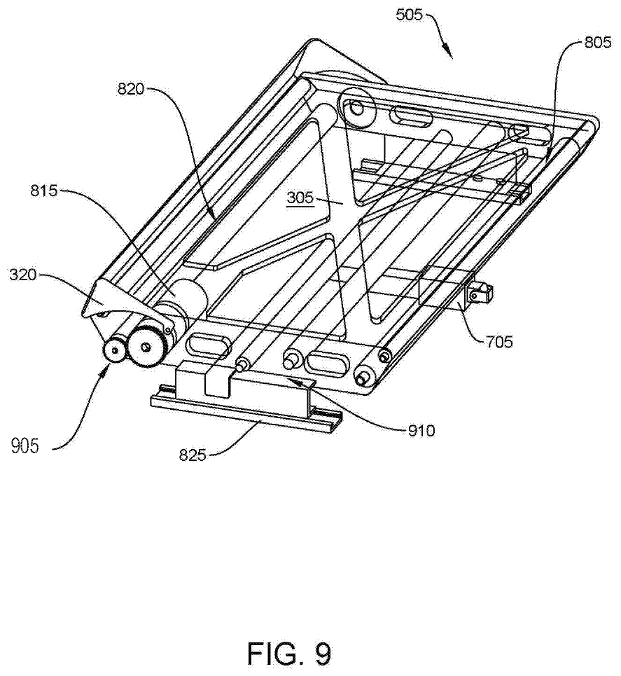

FIG. 9 is a partially transparent perspective view depicting details of belt conveyor 505. In FIG. 9, drive roller 820 is shown to be driven by gear motor 815 (directed by controller 115) using gears 905. A take up screw 910 may be adjusted to remove slack from belt 305.

FIG. 10B is a partial side view depicting details of belt conveyor 505. In FIG. 10B, belt conveyor 505 is shown extended from chassis 310 (not shown) with front stop 320 in a lowered position. A cam follower 1005, which is mounted on chassis 310, indicates the position of conveyor 505 with respect to chassis 310 (contrast the position of cam follower 1005 in FIG. 10B where conveyor 505 is extended toward door 105 (FIG. 1) with the position of cam follower 1005 in FIG. 10A where conveyor 505 is retracted from door 105). When conveyor 505 is in the extended position of FIG. 10B cam follower 1005 has moved to the left along cam edge 1010 allowing front stop 320 to drop to the lowered position, which allows conveyor 505 to dispense product from the front (right side) of conveyor 505.

FIG. 10A is a partial side view depicting details of belt conveyor 505 from an embodiment of a belt conveyor product. In FIG. 10A, conveyor 505 is retracted with respect to chassis 310 causing cam follower 1005 to move along cam edge 1010 and raise front stop 320, which prevents product from being dispensed from the front of conveyor 505.

An embodiment of a method for delivering a product includes the following, directed by controller 115 with input from interface panel 110 and the sensors of bucket 300 and positioning system 200. Initially, the dispensing door 105 of the vending machine is in a closed position. A user chooses a product, e.g., from interface panel 110 on the front of vending machine 100. In a first step, bucket 300 is moved to the product on the shelf (row and column) by positioning mechanism 200 as directed by controller 115. In a second step, curtain 315 is opened. In a third step, conveyor belt 305 is moved to the shelf (retracted) by actuator 705 to close the space between the edge of the shelf and the nose of the conveyor. In a fourth step, one of the gear drives meshes with the appropriate divider gear. In a fifth step, the gear drive is rotated and the product is moved forward by the divider pusher. In a sixth step, the product is transferred by the divider pusher from the shelf of vending machine 100 to the rear end of conveyor belt 305. In a sixth step, a sensor (e.g., a light-based sensor or sensors or a weight-based sensor or sensors) detects the presence and location of the product on conveyor belt 305. In a seventh step, conveyor belt 305 is moved to position the product toward the center of the belt area within the chassis 310 with further confirming input from the sensor. In an eighth step, curtain 315 is closed. In a ninth step, bucket 300 moves to the dispensing area behind dispensing door 105. In a tenth step, the belt conveyor belt 305 is moved forward by actuator 705 to close the space or gap between the front of the belt conveyor belt 305 and the frame of the dispensing area door 105. In an eleventh step, the dispensing door 105 is opened, allowing the customer to withdraw the product. With curtain 315 closed, the customer has access to the purchased product, but not to other products within vending machine 100. In a twelfth step, the sensor detects the removal or absence of the product. In a thirteenth step, the dispensing door is closed. At this point, the system is waiting for another transaction. While the steps of this method may be performed in different order, in a specific embodiment curtain 315 is closed before dispensing door 105 is opened.

In an embodiment, the sensor detecting the presence and location of product on belt 305 is at least one light-based imaging sensor comparing present information to information regarding belt 305 when a product is not on belt 305, i.e., bucket 300 is “empty.” In an embodiment, the sensor detecting the presence and location of product on belt 305 is at least one weight-based sensor comparing present information to information regarding belt 305 when a product is not on belt 305, i.e., bucket 300 is “empty.”

In an embodiment, the sensor detecting the presence and location of product on belt 305 is a camera and the controller has access to image recognition software. In an embodiment, the camera and controller with image recognition software may scan and measure the position of each divider location, recognize the products in each position either by, e.g., scanning serial numbers, QR codes or image recognition.

In an embodiment, there are two cameras with LEDs in the top of the chassis. One camera with LEDs faces toward the shelf and can turn on to shine light on the product on the shelf. The camera can then read any QR codes, labels, barcodes, or optical character recognition, or even imaging recognition on the shelf to see what product or confirm what product it is looking at on the shelf. The camera could also be used to read a serial number of the product on the shelf and to track and record the serial number of that product to a database during the dispense process (knowing exactly which product is sold to whom when combined with information regarding the purchaser). The second camera is located in the top of the bucket that is directed straight down at the conveyor. The second camera may be used to also detect that the conveyor is “not empty”. In other words, this camera can be used as a sensor that detects the false negative. It may have access to an imaging library to know what an empty conveyor looks like, and then when it's “not empty” it knows that there's a product in the chassis and the positioning of that product in the chassis. Both cameras may be accessed by customer support through network connections to access and fix issues in the system and confirm inventory counts on the shelf. Both cameras can also be used to manage automated sequences such as correcting a mis-vended product or a product jam, or even removing end of life products from the assortment.

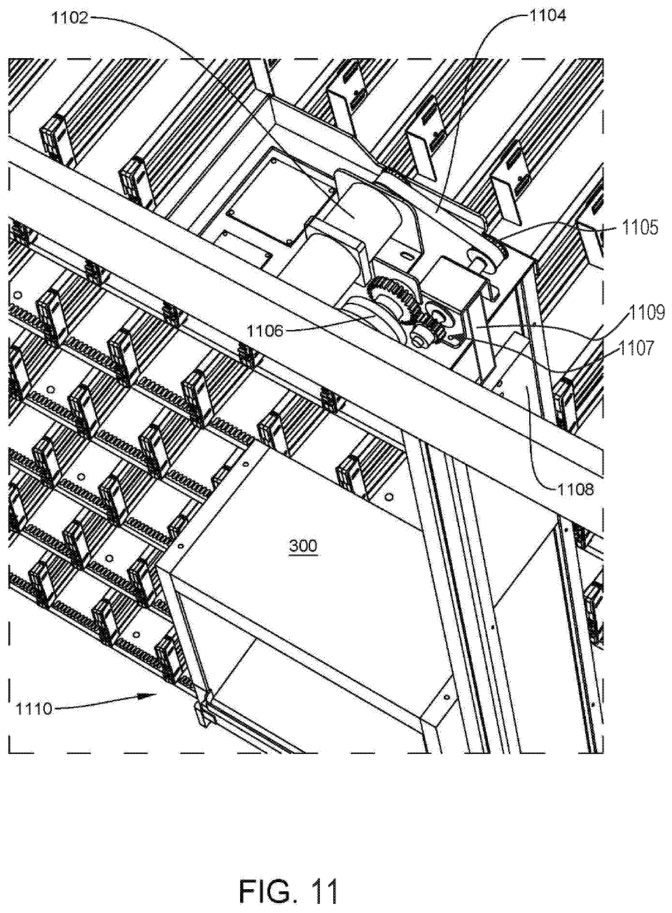

FIG. 11 is a partially transparent upper perspective view depicting details of an embodiment of positioning mechanism 200 for positioning belt conveyor bucket 300 within a vending machine. In FIG. 11, positioning mechanism 200 is directed by controller 115. Positioning mechanism 200 includes a Y-axis drive 1110, which itself includes a servo motor 1102, a timing belt 1104, a drive pulley 1105, an upper idler pulley (not shown), an electromagnetic brake 1106, brake gears 1107, a Y-positioning belt 1109, and a counter weight 1108. Drive 110 includes an upper idler pulley (not shown) on the axle between drive pulley 1105 and brake gears 1107. Electronic brake 1106 and servo motor 1102 are controlled by controller 115. Bucket 300 moves vertically along a rail 1111. Bucket 300 is connected to and positioned vertically by Y-positioning belt 1109. Servo motor 1102, as directed, drives bucket 300 to the proper vertical position by driving Y-positioning belt 1109 though timing belt 1104, and drive pulley 1105. Brake gears, also connected to drive pulley 1105, halt the movement of positioning belt 1109 at the proper position when braked by electronic brake 1106 as directed by controller 115 when data from Y-axis position sensors indicate bucket 300 is at the proper vertical position.

FIG. 12 is a perspective view depicting further details of Y-axis drive 1110 of positioning mechanism 200. In FIG. 12, Y-axis drive 1110 includes a lower idler pulley 1202. Y-positioning belt 1109 moved on lower idler pulley 1202 and the upper idler pulley (FIG. 11, not shown) when positioning bucket 300.

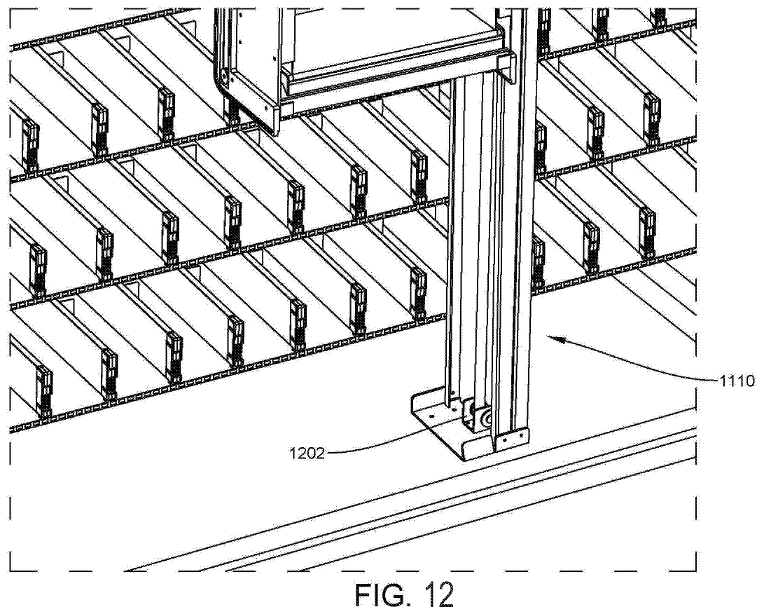

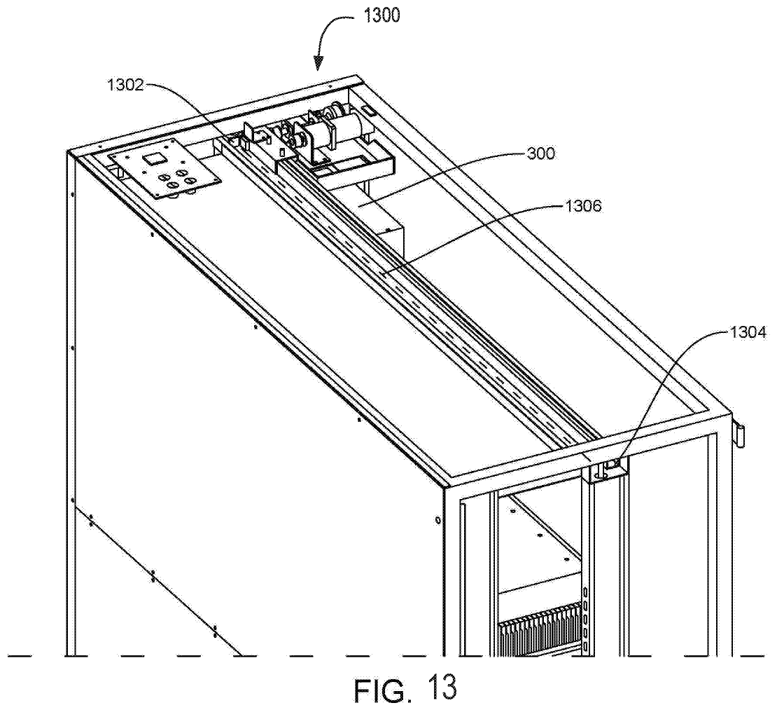

FIG. 13 is a perspective view depicting details of an X-axis drive 1300 of positioning mechanism 200 for positioning an embodiment of belt conveyor bucket 300 within vending machine 100. X-axis drive is directed by controller 115. In FIG. 13, X-axis drive 1300 includes an X-axis drive pulley 1302, an idler pulley 1304, and a timing belt 1306. X-axis drive 1300 moves Y-axis drive 1110 to position bucket 300 along the X-direction. Y-axis drive 1110 is connected to timing belt 1306. X-axis drive moves timing belt 1306 to position Y-axis drive 1110.

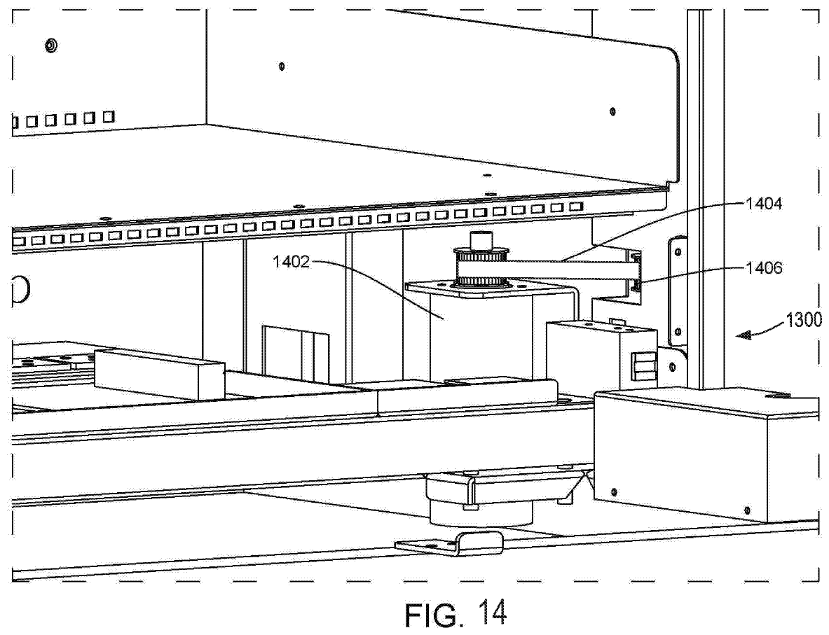

FIG. 14 is a perspective view depicting details of X-axis drive 1300 of positioning mechanism 200. In FIG. 14, X-axis drive 1300 further includes an X-axis servo motor 1402 and drive gear, a timing belt 1404, and a second X-axis drive pulley 1406. Controller 115 directs server motor 1402 to turn drive pulley 1406 via timing belt 1404.

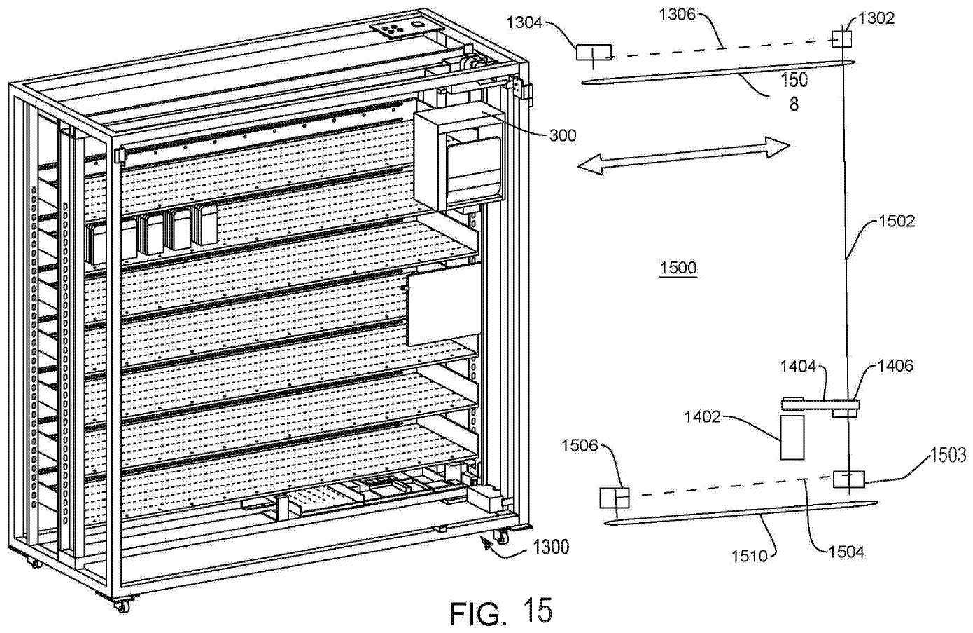

FIG. 15A is a schematic 1500 depicting details of X-axis drive 1300 of positioning mechanism 200 for positioning belt conveyor bucket 300 within vending machine 100. In FIG. 15A, X-axis drive 1300 further includes a shaft 1502, third X-axis drive pulley 1503, a timing belt 1504, an idler pulley 1506, a timing belt 1508, and linear rails 1508, 1510. Drive pulley 1406, driven by servo motor 1402 as directed by controller 115, causes shaft 1502 to turn and rotate drive pulleys 1302, 1503. Drive pulleys 1302, 1503 in turn cause timing belts 1306, 1510 to rotate around idler pulleys 1304, 1506, respectfully. Y-axis drive 1110 is connected to timing belts 1306, 1510 and moves horizontally along linear rails 1508, 1510 with the movement of timing belts 1306, 1510. In the embodiment, X-position sensors detect the X-axis position of Y-axis drive 1110 (and thereby bucket 300) and provide position data to controller 115.

FIG. 15B is a perspective view depicting details of X-axis drive 1300 of positioning mechanism 200 for positioning belt conveyor bucket 300 within vending machine 100. In FIG. 15B, X-axis drive 1300 is shown to move Y-axis drive 1110 along linear rails 1508, 1510 to position bucket 300 along the X axis.

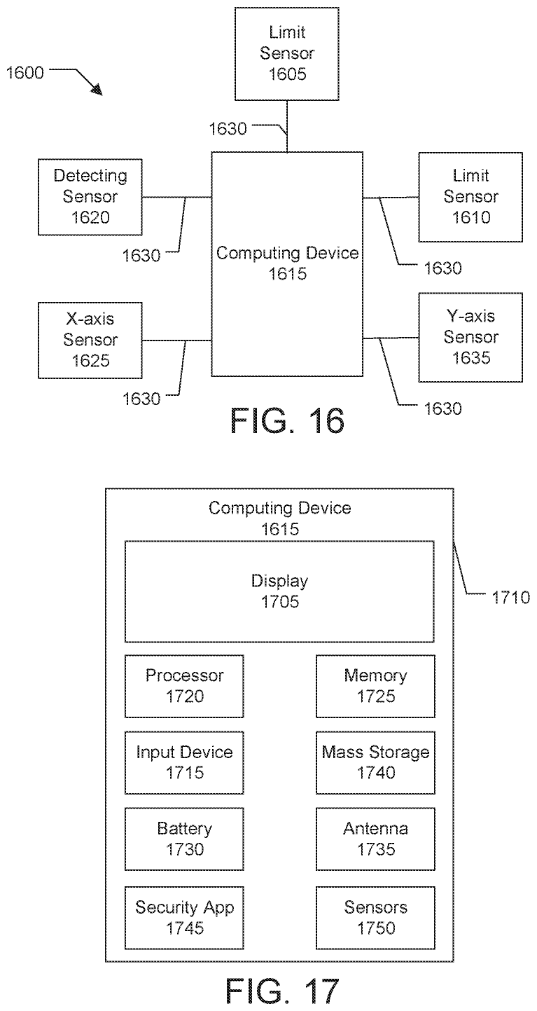

FIG. 16 is a simplified, exemplary block diagram of an embodiment of a system 1600 for implementing the embodiments of systems and methods disclosed herein. System 1600 may include a number of sensors, e.g., a curtain limit sensor 1605, a curtain limit sensor 1610, a product detecting and locating sensor 1620, a bucket X-axis location sensor 1625, and a bucket Y-axis location sensor 1635, for developing data regarding the position of a tab, a position of a dispenser, or a position of a conveyor bucket. Sensors 1605, 1610, 1620, 1625, and 1635 are in communication with a computing device 1615, e.g., controller 115 (FIG. 1). Computing device 1615 may further communicate with or be in control of bucket 300, curtain system 315, positioning system 200, dispenser door 105, and interface panel 110. Computing device 1615 may receive input from interface panel 110 and display information on interface panel 110. Sensors 1605, 1610, 1620, 1625, and 1635 may supply data to computing device 1615 via communication links 1630.

Computing device 1615 may include a user interface (e.g., interface panel 110) and software, which may implement the steps of the methods disclosed within. Computing device 1615 may receive data from sensors 1605, 1610, 1620, 1625, and 1635, via communication links 1630, which may be hardwire links, optical links, satellite or other wireless communications links, wave propagation links, or any other mechanisms for communication of information. Various communication protocols may be used to facilitate communication between the various components shown in FIG. 16. Distributed system 1600 in FIG. 16 is merely illustrative of an embodiment and does not limit the scope of the systems and methods as recited in the claims. In an embodiment, the elements of system 1600 are incorporated into a vending machine (e.g., vending machine 100). One of ordinary skill in the art would recognize other variations, modifications, and alternatives. For example, more than one computing device 1615 may be employed. As another example, sensors 1605, 1610, 1620, 1625, and 1635 may be coupled to computing device 1615 via a communication network (not shown) or via some other server system.

Computing device 1615 may be responsible for receiving data from sensors 1605, 1610, 1620, 1625, and 1635, performing processing required to implement the steps of the methods, and for interfacing with the user. In some embodiments, computing device 1615 may receive processed data from sensors 1605, 1610, 1620, 1625, and 1635. In some embodiments, the processing required is performed by computing device 1615. In such embodiments, computing device 1615 runs an application for receiving user data, performing the steps of the method, and interacting with the user. In other embodiments, computing device 1615 may be in communication with a server, which performs the required processing, with computing device 1615 being an intermediary in communications between the user and the processing server.

System 1600 may enable users to access and query information developed by the disclosed methods. Some example computing devices 1615 include devices running the Apple iOS®, Android® OS, Google Chrome® OS, Symbian OS®, Windows Mobile® OS, Windows Phone, BlackBerry® OS, Embedded Linux, Tizen, Sailfish, webOS, Palm OS® or Palm Web OS®.

FIG. 17 is an exemplary block diagram of a computing device 1615 from the system of FIG. 16. In an embodiment, a user interfaces with the system through computing device 1615, which also receives data and performs the computational steps of the embodiments. Computing device 1615 may include a display, screen, or monitor 1705, housing 1710, input device 1715, sensors 1750, and a security application 1745. Housing 1710 houses familiar computer components, some of which are not shown, such as a processor 1720, memory 1725, battery 1730, speaker, transceiver, antenna 1735, microphone, ports, jacks, connectors, camera, input/output (I/O) controller, display adapter, network interface, mass storage devices 1740, and the like. In an embodiment, sensors 1750 may include sensors 1605, 1610, 1620, 1625, and 1635 in communication with computing device 1615

Input device 1715 may also include a touchscreen (e.g., resistive, surface acoustic wave, capacitive sensing, infrared, optical imaging, dispersive signal, or acoustic pulse recognition), keyboard (e.g., electronic keyboard or physical keyboard), buttons, switches, stylus, or combinations of these. Input device 1715 may be incorporated into interface panel 110.

Display 1705 may include dedicated LEDs for providing directing signals and feedback to a user. Display device 1705 may be incorporated into interface panel 110.

Mass storage devices 1740 may include flash and other nonvolatile solid-state storage or solid-state drive (SSD), such as a flash drive, flash memory, or USB flash drive. Other examples of mass storage include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), battery-backed-up volatile memory, tape storage, reader, and other similar media, and combinations of these.

System 1700 may also be used with computer systems having configurations that are different from computing device 1615, e.g., with additional or fewer subsystems. For example, a computer system could include more than one processor (i.e., a multiprocessor system, which may permit parallel processing of information) or a system may include a cache memory. The computing device 1615 shown in FIG. 17 is but an example of a computer system suitable for use. For example, in a specific implementation, computing device 1615 is mounted to a vending machine and in communication with the sensors and systems of the vending machine. Other configurations of subsystems suitable for use will be readily apparent to one of ordinary skill in the art.

The following paragraphs provide enumerated embodiments.

1. An apparatus comprising: a positioning system; a chassis connected to the positioning system and defining a space with a front opening and a rear opening; a belt conveyor disposed within the defined space and including a belt surface movable between the front opening and the rear opening; and a partition configured to move between a closed position and an open position, the rear opening closed when the partition is in the closed position and open when the partition is in the open position, the partition in the closed position preventing access through the rear opening to an interior of a vending machine.

2. The apparatus of embodiment 1 further comprising a controller connected to a user interface, wherein: the chassis is positioned between a front wall of the vending machine and shelving of the vending machine; the positioning system, at the direction of the controller upon receipt of input from the user interface, is configured to move the chassis from a dispensing position behind a door located in the front wall to a loading position in front of any of a plurality of locations along the shelving; and with the chassis in the dispensing position, the chassis and partition block access to the shelving when the door is opened.

3. The apparatus of embodiment 1 further comprising a first actuator connected between the chassis and the belt conveyor, the actuator moving the belt conveyor between an extended position and a retracted position with the belt conveyor more toward the front opening in the extended position, the extended position reducing a first gap between the belt conveyor and a door of the vending machine, the retracted position reducing a second gap between the belt conveyor and a shelf of the vending machine.

4. The apparatus of embodiment 3 further comprising: a front barrier pivotably connected to the belt conveyor and including a cam edge between the front barrier and a pivot point; and a cam follower attached to the chassis, wherein the front barrier is movable between a raised position and a lowered position and is urged into the raised position by retraction of the belt conveyor and corresponding movement of the cam follower along the cam edge.

5. The apparatus of embodiment 1 further comprising a gear drive, a gear drive actuator, a linear guide, a drive motor, and a drive belt, the gear drive disposed on a first side of the chassis and movable by the gear drive actuator to engage a shelf divider of the vending machine, the movement of the gear drive constrained by the linear guide, and the movement of the gear drive being relative to the chassis.

6. The apparatus of embodiment 1 further comprising a first gear drive, a first gear drive actuator, a second gear drive, and a second gear drive actuator, the first gear drive disposed on a first side of the chassis, the second gear drive disposed on a second side of the chassis, the first gear drive movable by the first gear drive actuator to engage a first shelf divider of the vending machine, the second gear drive movable by the second gear drive actuator to engage a second shelf divider of the vending machine.

7. The apparatus of embodiment 6, wherein the first gear drive may engage the first shelf divider and the second gear drive may engage the second shelf divider simultaneously.

8. The apparatus of embodiment 7 further comprising a first spring and a second spring, the first spring positioned between the first gear drive actuator and the first gear drive and configured to compress when the first gear drive contacts the first shelf divider before the first gear drive actuator has fully actuated, the second spring positioned between the second gear drive actuator and the second gear drive and configured to compress when the second gear drive contacts the second shelf divider before the second gear drive actuator has fully actuated, whereby the first and second springs provide for misalignment of the chassis with respect to the first shelf divider and second shelf divider.

9. The apparatus of embodiment 1 further comprising at least one sensor and a controller, the at least one sensor providing the controller with information regarding whether a product is on the belt surface and a location of the product on the belt surface.

10. The apparatus of embodiment 1, wherein the positioning system includes: a controller, an X-axis drive and a Y-axis drive; the Y-axis drive including a first motor controlled by the controller, a first positioning belt connected to the chassis, and a first rail on which the chassis may move in the Y-direction, the first motor configured to drive the first positioning belt to position the chassis along the first rail; the X-axis drive including a second motor controlled by the controller, a second positioning belt, and a second rail on which the Y-axis drive may move in the X-direction, the second motor configured to drive the second positioning belt to position the Y-axis drive along the second rail.

11. A method for delivering a product comprising: receiving, by a processor from a user interface, a selection of a product; moving, by a positioning system at the direction of the processor, a chassis to a location within a vending machine associated with the product; positioning, by the chassis at the direction of the processor, a belt conveyor of the chassis toward the location associated with the product; engaging, by movement of an actuator at the direction of the processor, a drive gear of the chassis to a divider gear associated with the product; and rotating, by the drive gear at the direction of the processor, the divider gear to dispense the product from the shelf to the belt conveyor.

12. The method of embodiment 11, further comprising: sensing, by a sensor in communication with the processor, a location of the product on the belt conveyor; and positioning, by the belt conveyor at the direction of the processor, the product toward the center of a belt area.

13. The method of embodiment 11, further comprising: closing, by the chassis at the direction of the processor, a partition preventing access through the chassis to an interior of the vending machine.

14. The method of embodiment 13, further comprising: moving, by the positioning system at the direction of the processor, the chassis to a location within a vending machine associated with a dispensing door; positioning, by the chassis at the direction of the processor, the belt conveyor toward the location associated with the dispensing door; opening, by the vending machine at the direction of the processor, the dispensing door.

15. The method of embodiment 14, further comprising: sensing, by a sensor in communication with the processor, an absence of the product from the belt conveyor; and closing, by the vending machine at the direction of the processor, the dispensing door.

16. A non-transitory, computer-readable storage medium having stored thereon a plurality of instructions, which, when executed by a processor of a vending machine, cause the vending machine to: receive, from a user interface, a selection of a product; move, by a positioning system, a chassis to a location within a vending machine associated with the product; position, by the chassis, a belt conveyor of the chassis toward the location associated with the product; engage, by movement of an actuator, a drive gear of the chassis to a divider gear associated with the product; and rotate, by the drive gear, the divider gear to dispense the product from the shelf to the belt conveyor.

17. The computer-readable storage medium of embodiment 16, the instructions further causing the vending machine to: sense, by a sensor, a location of the product on the belt conveyor; and position, by the belt conveyor, the product toward the center of a belt area.

18. The computer-readable storage medium of embodiment 16, the instructions further causing the vending machine to: close, by the chassis, a partition preventing access through the chassis to an interior of the vending machine.

19. The computer-readable storage medium of embodiment 18, the instructions further causing the vending machine to: move, by the positioning system, the chassis to a location within a vending machine associated with a dispensing door; position, by the chassis, the belt conveyor toward the location associated with the dispensing door; and open, by the vending machine, the dispensing door.

20. The computer-readable storage medium of embodiment 19, the instructions further causing the vending machine to: sense, by a sensor in communication with the processor, an absence of the product from the belt conveyor; and close, by the vending machine, the dispensing door.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples, and are not meant to be limiting in any way. Other steps and functions may be contemplated without departing from this disclosure or the scope of an embodiment.

What is claimed is:

1. An apparatus comprising:
a positioning system;
a chassis connected to the positioning system and defining a space with a front opening and a rear opening;
a belt conveyor disposed within the defined space and including a belt surface movable between the front opening and the rear opening; and
a partition configured to move between a closed position and an open position, the rear opening closed when the partition is in the closed position and open when the partition is in the open position, the partition in the closed position preventing access through the rear opening to an interior of a vending machine.

2. The apparatus of claim 1 further comprising a controller connected to a user interface, wherein:
the chassis is positioned between a front wall of the vending machine and shelving of the vending machine;
the positioning system, at the direction of the controller upon receipt of input from the user interface, is configured to move the chassis from a dispensing position behind a door located in the front wall to a loading position in front of any of a plurality of locations along the shelving; and
with the chassis in the dispensing position, the chassis and partition block access to the shelving when the door is opened.

3. The apparatus of claim 1 further comprising a first actuator connected between the chassis and the belt conveyor, the actuator moving the belt conveyor between an extended position and a retracted position with the belt conveyor more toward the front opening in the extended position, the extended position reducing a first gap between the belt conveyor and a door of the vending machine, the retracted position reducing a second gap between the belt conveyor and a shelf of the vending machine.

4. The apparatus of claim 3 further comprising:
a front barrier pivotably connected to the belt conveyor and including a cam edge between the front barrier and a pivot point; and
a cam follower attached to the chassis, wherein the front barrier is movable between a raised position and a lowered position and is urged into the raised position by retraction of the belt conveyor and corresponding movement of the cam follower along the cam edge.

5. The apparatus of claim 1 further comprising a gear drive, a gear drive actuator, a linear guide, a drive motor, and a drive belt, the gear drive disposed on a first side of the chassis and movable by the gear drive actuator to engage a shelf divider of the vending machine, the movement of the gear drive constrained by the linear guide, and the movement of the gear drive being relative to the chassis.

6. The apparatus of claim 1 further comprising a first gear drive, a first gear drive actuator, a second gear drive, and a second gear drive actuator, the first gear drive disposed on a first side of the chassis, the second gear drive disposed on a second side of the chassis, the first gear drive movable by the first gear drive actuator to engage a first shelf divider of the vending machine, the second gear drive movable by the second gear drive actuator to engage a second shelf divider of the vending machine.

7. The apparatus of claim 6, wherein the first gear drive may engage the first shelf divider and the second gear drive may engage the second shelf divider simultaneously.

8. The apparatus of claim 7 further comprising a first spring and a second spring, the first spring positioned between the first gear drive actuator and the first gear drive and configured to compress when the first gear drive contacts the first shelf divider before the first gear drive actuator has fully actuated, the second spring positioned between the second gear drive actuator and the second gear drive and configured to compress when the second gear drive contacts the second shelf divider before the second gear drive actuator has fully actuated, whereby the first and second springs provide for misalignment of the chassis with respect to the first shelf divider and second shelf divider.

9. The apparatus of claim 1 further comprising at least one sensor and a controller, the at least one sensor providing the controller with information regarding whether a product is on the belt surface and a location of the product on the belt surface.

10. The apparatus of claim 1, wherein the positioning system includes:
a controller, an X-axis drive and a Y-axis drive;
the Y-axis drive including a first motor controlled by the controller, a first positioning belt connected to the chassis, and a first rail on which the chassis may move in the Y-direction, the first motor configured to drive the first positioning belt to position the chassis along the first rail;
the X-axis drive including a second motor controlled by the controller, a second positioning belt, and a second rail on which the Y-axis drive may move in the X-direction, the second motor configured to drive the second positioning belt to position the Y-axis drive along the second rail.

11. A method for delivering a product comprising:
receiving, by a processor from a user interface, a selection of a product;
moving, by a positioning system at the direction of the processor, a chassis to a location within a vending machine associated with the product;
positioning, by the chassis at the direction of the processor, a belt conveyor of the chassis toward the location associated with the product;
engaging, by movement of an actuator at the direction of the processor, a drive gear of the chassis to a divider gear associated with the product; and
rotating, by the drive gear at the direction of the processor, the divider gear to dispense the product from the shelf to the belt conveyor.

12. The method of claim 11, further comprising:
sensing, by a sensor in communication with the processor, a location of the product on the belt conveyor; and
positioning, by the belt conveyor at the direction of the processor, the product toward the center of a belt area.

13. The method of claim 11, further comprising:
closing, by the chassis at the direction of the processor, a partition preventing access through the chassis to an interior of the vending machine.

14. The method of claim 13, further comprising:
moving, by the positioning system at the direction of the processor, the chassis to a location within a vending machine associated with a dispensing door;
positioning, by the chassis at the direction of the processor, the belt conveyor toward the location associated with the dispensing door;
opening, by the vending machine at the direction of the processor, the dispensing door.

15. The method of claim 14, further comprising:
sensing, by a sensor in communication with the processor, an absence of the product from the belt conveyor; and
closing, by the vending machine at the direction of the processor, the dispensing door.

16. A non-transitory, computer-readable storage medium having stored thereon a plurality of instructions, which, when executed by a processor of a vending machine, cause the vending machine to:
receive, from a user interface, a selection of a product;
move, by a positioning system, a chassis to a location within a vending machine associated with the product;
position, by the chassis, a belt conveyor of the chassis toward the location associated with the product;
engage, by movement of an actuator, a drive gear of the chassis to a divider gear associated with the product; and
rotate, by the drive gear, the divider gear to dispense the product from the shelf to the belt conveyor.

17. The computer-readable storage medium of claim 16, the instructions further causing the vending machine to:
sense, by a sensor, a location of the product on the belt conveyor; and
position, by the belt conveyor, the product toward the center of a belt area.

18. The computer-readable storage medium of claim 16, the instructions further causing the vending machine to:
close, by the chassis, a partition preventing access through the chassis to an interior of the vending machine.

19. The computer-readable storage medium of claim 18, the instructions further causing the vending machine to:
move, by the positioning system, the chassis to a location within a vending machine associated with a dispensing door;
position, by the chassis, the belt conveyor toward the location associated with the dispensing door; and
open, by the vending machine, the dispensing door.

20. The computer-readable storage medium of claim 19, the instructions further causing the vending machine to:
sense, by a sensor in communication with the processor, an absence of the product from the belt conveyor; and
close, by the vending machine, the dispensing door.
